(19) United States
(12) Patent Application Publication
(10) Pub. No.: US 2026/0052172 A1
(43) Pub. Date: Feb. 19, 2026

(54) DENIAL-OF-SERVICE (DOS) ATTACK PREVENTION IN A SECURITY PROTOCOL

(71) Applicant: ENTERSEKT INTERNATIONAL LIMITED, Cybercity (MU)

(72) Inventor: Eirik ØVERBY, Oslo (NO)

(21) Appl. No.: 19/300,176

(22) Filed: Aug. 14, 2025

(30) Foreign Application Priority Data
Aug. 15, 2024 (ZA) 2024/06253

(51) Int. Cl. H04L 9/40

(52) U.S. Cl. CPC H04L 63/1458; H04L 63/0254; H04L 63/166

(57) ABSTRACT

A method and system for a denial-of-service attack prevention in a security protocol is provided. The method may include obtaining validation information usable in validating a connection request for use in compiling a uniform resource identifier (URI). The URI may be usable by an end-user device in connecting to a security protocol computing device over a public network. The validation information may be included in a security protocol response message and transmitting the response message to an endpoint via a private network. The method may include receiving a request to connect to the security protocol computing device via a public network using the URI. The method may include validating the request using the validation information and permitting connection to the security protocol computing device.

### CROSS-REFERENCE(S) TO RELATED APPLICATIONS

This application claims priority from South African provisional patent application number 2024/06253 filed on 15 Aug. 2024, which is incorporated by reference herein.

### FIELD

This disclosure relates to a system and method for denial-of-service (DoS) attack prevention in a security protocol.

### BACKGROUND

A “denial-of-service” (DoS) attack typically refers to a cyber-attack in which a perpetrator seeks to make a network resource, such as a computing device accessible via a network, unavailable to its intended users by temporarily or indefinitely disrupting services of the computing device. Such attacks are typically implemented by flooding the targeted network resource with superfluous requests in an attempt to overload the computing device and/or associated devices and thus to prevent some or all legitimate requests from being fulfilled.

Increasingly, such attacks are being carried out on security protocol infrastructure, such as so-called “three-domain secure” (3DS) security protocol infrastructure. For example, perpetrators can initiate DoS attacks against an access control server (ACS) using a known, publicly available uniform resource locator (URL) that points to the ACS. In some examples, requests, such as challenge requests, destined for the ACS are rerouted to a stand-in server while the ACS is being subjected to a DoS attack. Oftentimes, the stand-in server is configured to bypass such requests which can expose vulnerabilities in the security protocol that can be exploited for the duration of the DoS attack. For example, if a challenge request is bypassed, a fraudulently submitted transaction will not trigger second factor or out of band authentication of the transaction and may therefore succeed.

While there are mechanisms by which a computing device can be protected from DoS attacks, there remains scope for improvement.

The preceding discussion of the background is intended only to facilitate an understanding of the present disclosure. It should be appreciated that the discussion is not an acknowledgment or admission that any of the material referred to was part of the common general knowledge in the art as at the priority date of the application.

### SUMMARY

In accordance with an aspect of the disclosure there is provided a computer-implemented method for a denial-of-service attack prevention in a security protocol, the method comprising:
obtaining validation information usable in validating a connection request for use in compiling a uniform resource identifier (URI) usable by an end-user device in connecting to a security protocol computing device over a public network;
including the validation information in a security protocol response message and transmitting the security protocol response message to an endpoint via a private network; and,
in response to receiving, via the public network, a request to connect to the security protocol computing device using the URI, validating the request using the validation information and permitting connection to the security protocol computing device.

The method may include compiling the URI. The URI may include the validation information. Including the validation information in the security protocol response message may include including the compiled URI including the validation information in the security protocol response message.

The URI may point to the security protocol computing device in a domain name system (DNS). The URI may include a domain name including a first part and a second part which contains the validation information. The second part of the URI may be a third or lower level domain field of the domain name. The method may include configuring the DNS to include a wildcard DNS record based on the first part of the domain name.

Compiling the URI may include defining a fully qualified domain name (FQDN) using the validation information. This may allow spurious requests submitted to the security protocol computing device via spurious URIs to be detected and rejected before a transport layer security (TLS) protocol handshake establishing a TLS session. The URI may be a uniform resource locator (URL).

The validation information may be limited-use information. The validation information may be valid for a limited period of time. The method may repeat periodically to obtain new validation information. The validation information may be activity- or session-specific. The validation information may be in the form of a token uniquely generated for an end-user activity. Obtaining the validation information may be in response to a security protocol authentication request for a transaction, and the method may repeat for each transaction.

Obtaining the validation information may include obtaining the validation information from a data store, such as a key-value store. The data store may form part of security protocol infrastructure and may be configured to store transaction tokens temporarily for in-progress transactions. Using the validation information to validate the request may include validating the validation information. Validating the validation information may include searching the data store for the validation information.

The method may include, in response to receiving a request to connect to the security protocol computing device via another URI which does not include the validation information, failing to validate the request and declining to permit the connection.

The security protocol message may be a security protocol authentication response sent via a security protocol directory server. The security protocol may be the three-domain secure (“3DS”) security protocol and the security protocol computing device may be an access control server (ACS).

In accordance with a further aspect of the disclosure there is provided a system for a denial-of-service attack prevention in a security protocol, the system comprising: a non-transitory computer-readable storage medium; and one or more processors coupled to the non-transitory computer-readable storage medium, wherein the non-transitory computer-readable storage medium comprises program instructions that, when executed on the one or more processors, cause the system to perform operations comprising:
obtaining validation information usable in validating a connection request for use in compiling a uniform resource identifier (URI) usable by an end-user device in connecting to a security protocol computing device over a public network;
including the validation information in a security protocol response message and transmitting the security protocol response message to an endpoint via a private network; and,
in response to receiving, via the public network, a request to connect to the security protocol computing device using the URI, validating the request using the validation information and permitting connection to the security protocol computing device.

In accordance with a further aspect of the disclosure there is provided a system for a denial-of-service attack prevention in a security protocol, the system including a memory for storing computer-readable program code and a processor for executing the computer-readable program code, the system comprising:
an information obtaining component for obtaining validation information usable in validating a connection request for use in compiling a uniform resource identifier (URI) usable by an end-user device in connecting to a security protocol computing device over a public network;
a response message generating and transmitting component for including the validation information in a security protocol response message and transmitting the security protocol response message to an endpoint via a private network; and,
a connection control component for, in response to receiving, via the public network, a request to connect to the security protocol computing device using the URI, validating the request using the validation information and permitting connection to the security protocol computing device.

In accordance with a further aspect of the disclosure there is provided a computer program product for a denial-of-service attack prevention in a security protocol, the computer program product comprising a computer-readable medium having stored computer-readable program code for performing the steps of:
obtaining validation information usable in validating a connection request for use in compiling a uniform resource identifier (URI) usable by an end-user device in connecting to a security protocol computing device over a public network;
including the validation information in a security protocol response message and transmitting the security protocol response message to an endpoint via a private network; and,
in response to receiving, via the public network, a request to connect to the security protocol computing device using the URI, validating the request using the validation information and permitting connection to the security protocol computing device.

Further features provide for the computer-readable medium to be a non-transitory computer-readable medium and for the computer-readable program code to be executable by a processing circuit.

Embodiments of the technology will now be described, by way of example only, with reference to the accompanying drawings.

### BRIEF DESCRIPTION OF THE DRAWINGS

In the drawings:

FIG. 1A is a schematic diagram which illustrates an exemplary system for denial-of-service (DoS) attack prevention in a security protocol according to aspects of the present disclosure;

FIG. 1B is a schematic diagram which illustrates an example domain name system (DNS) record in a DNS according to aspects of the present disclosure;

FIG. 1C is a schematic diagram which illustrates an example uniform resource identifier (URI) according to aspects of the present disclosure;

FIG. 1D is a schematic diagram which illustrates another example URI according to aspects of the present disclosure;

FIG. 2A a flow diagram which illustrates a first part of an example method for DoS attack prevention in a security protocol according to aspects of the present disclosure;

FIG. 2B a flow diagram which illustrates a second part of the example method for DoS attack prevention in a security protocol;

FIG. 3 is a swim-lane flow diagram which illustrates an example method for DoS attack prevention in a security protocol according to aspects of the present disclosure;

FIG. 4 is a block diagram which illustrates exemplary components which may be provided by a system for DoS attack prevention in a security protocol according to aspects of the present disclosure; and,

FIG. 5 illustrates an example of a computing device in which various aspects of the disclosure may be implemented.

### DETAILED DESCRIPTION WITH REFERENCE TO THE DRAWINGS

A system and method for denial-of-service (DoS) attack prevention in a security protocol are provided. The security protocol may provide or use a private network, a security protocol computing device and a security protocol endpoint. The endpoint may be in communication with an end-user device via a public network.

The method, which may be conducted by one or more computing devices maintained or operated by or on behalf of an entity, may include obtaining validation information usable in validating a connection request. The validation information may be obtained for use in compiling a uniform resource identifier (URI). The URI may be usable by an end-user device in connecting to the security protocol computing device over the public network. The method may include inserting or including the validation information in a security protocol response message and transmitting the security protocol response message to an endpoint via the private network. In some examples, this includes inserting or including a URI including the validation information in the security protocol response message. In other examples, the validation information and instructions for compiling the URI including or based on the validation information are included in the security protocol response message. The method may include, in response to receiving, via the public network, a request to connect to the security protocol computing device using the URI, validating the request using the validation information and permitting connection to the security protocol computing device in response to determining that the request is valid.

The validation information may be in the form of a character string and may be included as part of the URI used to submit the request to connect to the security protocol computing device. The URI may be a unique sequence of characters that identifies an abstract or physical resource, such as resources on a webpage. Generally, a URI which provides a means of locating and retrieving information resources on a network is termed a uniform resource locator (URL). Therefore, as used herein, a “URL” is considered a subset of URIs. In some examples, therefore, the URI may be a URL. A URL may colloquially be known as an address on the Web and may be a reference to a resource that specifies its location on a computer network and a mechanism for retrieving it.

Thus, a unique and/or time-limited URI may be created for accessing the security protocol computing device over the public network. The URI may be distributed securely, via the private network. In this manner, an attack surface of the security protocol computing device may be minimised by minimising the period of time for which the URI is usable in connecting to the security protocol computing device. Old or expired URIs, or spurious URIs, may be unusable in connecting to the security protocol computing device over the public network. In this manner, a DoS attacker's ability to initiate a DoS attack against the security protocol computing device may be frustrated.

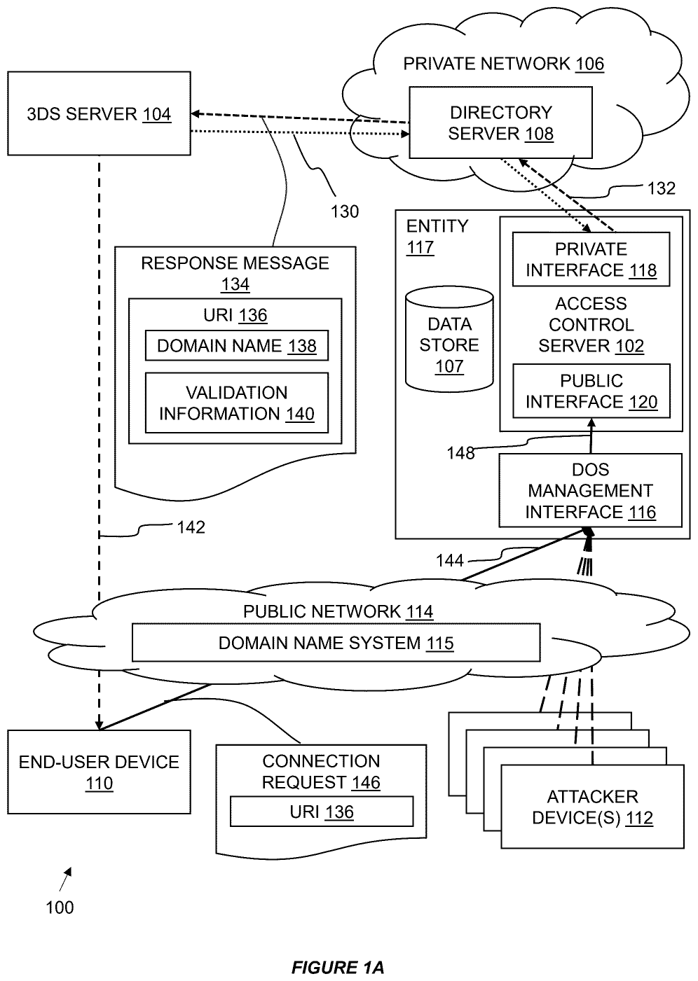

FIG. 1A is a schematic diagram which illustrates an exemplary system (100) for DoS attack prevention in a security protocol. In the example illustrated in FIG. 1A, the security protocol is the three-domain secure (3DS) security protocol.

The system may include a security protocol computing device (102) which may for example be an access control server (ACS). The system may further include a security protocol endpoint (104), such as a 3DS server (or merchant plug-in), which is in data communication with the ACS via a private network (106). Each of the 3DS server, directory server and ACS may be provided by respective computing devices, each of which may be configured to perform a server role.

In some examples, the ACS has access to a data store (107), which may be a security protocol data store. The data store may be a key-value data store. The data store may be an “in-flight” data store in that it stores data relating in-progress end-user activities. The terms in-flight or in-progress may be used interchangeably. This may include in-flight data being transmitted between one or more of the security protocol endpoint, security protocol computing device, and end-user device. The data store may for example store tokens or identifiers relating to end-user activities which are pending, in-progress, or the like. In this manner, a token or identifier which uniquely identifies an end-user activity may be stored in the data store in response to initiation of the end-user activity and may be removed from the data store in response to finalisation or completion of the end-user activity.

The private network may include or may be provided by a directory server (DS) (108). The private network may require authentication or validation of devices before permitting them to communicate via the network. For example, a device may need to submit a credential, such as a certificate, public key or the like, to the private network (or to the DS) for validation before being permitted to join and/or communicate via the network.

The system may further include an end-user device (110) and one or more attacker devices (112). The end-user device and one or more attacker devices may be computing devices and may be capable of connecting to the ACS via a public network (114), such as the internet. The public network may include or have access to a domain name system (DNS) (115) which translates domain names to internet protocol (IP) addresses needed for locating and identifying computing devices over the public network. The DNS may for example include a mapping of a domain name to an IP address of the ACS.

In some examples, the DNS includes a wildcard mapping of a range of domain names to the domain name and/or IP address of the ACS. The wildcard mapping may be via a wildcard DNS record which matches or maps requests for non-existent domain names. In some examples, referring now to FIG. 1B, the DNS may include a DSN record (124) which maps a wild card domain (126) to the domain name and/or IP address (128) of the ACS. In some examples, the DNS record is a wildcard DNS record that matches requests for non-existent domain names. The wildcard DNS record may be specified by using an asterisk (*) as the leftmost label (part) of a domain name (e.g. “*.example.com”). In some examples, the wildcard DNS record in the zone file maps a wildcard domain to an actual domain of the ACS. In this way, in some examples, the wildcard DNS record may cause DNS lookups on domain names ending in “example.com” that do not exist to have records synthesized for them. Thus, a connection request using a domain name “a3e2c5.example.com” may be mapped to “acs.example.com.”

Returning to FIG. 1A, the system may further include a DoS management interface (116) which regulates and/or controls access to the ACS via the public network. The DoS management interface may for example be configured to prevent and/or mitigate DoS attacks on the ACS.

One or more of the ACS, data store and DoS management interface may be controlled, operated and/or maintained by or on behalf of an entity (117) which participates in the security protocol.

The security protocol may require messages to be sent between one or more of the end-user device, 3DS server and ACS for the purpose of authentication. For example, in response to an end-user activity (or a purported end-user activity), the 3DS server may be configured to transmit (130) a security protocol request message (e.g., an authentication request, “ARes”) message to the ACS. The security protocol request message may be transmitted via the private network and may be received at the ACS via a private interface (118) thereof. The end-user activity may have been initiated from the end-user device. Initiation of the end-user activity may have caused establishment of a connection between the 3DS server and the end-user device over the public network. The connection may be a secure connection.

In response to receiving the request message, the ACS may determine that an action, such as a challenge action, is required and may respond by transmitting (132) a security protocol response message (134) (such as an authentication response, “ARes”) message to the 3DS server. The security protocol response message may be transmitted from the private interface of the ACS to the 3DS server via the private network. The security protocol response message may indicate to the 3DS server that a challenge action is required.

In some examples, the ACS includes or inserts a uniform resource indicator (URI) (136) in the security protocol response message. In other examples, the ACS includes validation information for compiling a URI. Two example URIs are illustrated in FIGS. 1C and 1D respectively. The URI may include a domain name (138) (e.g., “example.com”) and a path (139), which typically follows a forward slash. The URI may be usable in connecting to the ACS via the public network and a public interface of the ACS.

The URI may further include validation information (140) usable in validating a connection request which includes the URI. The validation information may be use-limited, time-limited and/or unique to the end-user activity and/or the action which is required to be performed. In some examples, the validation information is in the form of a character string. The character string may for example be or represent a token (such as a cryptographic token), an identifier, a nonce or the like. In some examples, the character string includes a proof-of-work token.

The validation information (e.g., “a3e2c5”) may be included in the path of the URI (such as: “https://acs.example.com/server/?info=a3e2c5”), as illustrated in the example URI of FIG. 1C.

Alternatively, the validation information may be included as a part of the domain name (such as “https://a3e2c5.example.com/server/”), as illustrated in FIG. 1D, to define a fully qualified domain name (FQDN) including the validation information at, e.g., a third or lower level of the domain name. For example, the domain name may include a first part (i.e., “example.com” in the example of FIG. 1D) and a second part which contains the validation information (i.e., “a3e2c5” in the example of FIG. 1D) The first part and second part of the domain name may be separated by a period (“.”). The first part of the domain name may be a higher level than the second part. The second part of the URI may be a third or lower level domain field of the domain name. The first part of the domain name may correspond to a wildcard DNS record based on the first part of the URI (e.g., “*.example.com”).

In response to receiving the response message, the 3DS server may transmit (142) the URI (or the validation information for compiling the URI) to the end-user device via the public network. Transmission via the public network may be a secure connection over the public network. The end-user device may in turn use the URI to submit (144) a connection request (146) to the ACS via the public network.

The DoS management interface may be configured to validate the validation information included in the URI. The DoS management interface may for example be configured to permit the connection request from the end-user device if the validation information is determined to be valid. The DoS management interface may be configured to refuse the connection request if the validation information is determined to be invalid. Because the connection request submitted from the end-user device includes the validation information usable in validating the connection request, the connection request may succeed (148) and the end-user device may be connected to the ACS via the public interface thereof.

In this manner, the one or more attacker devices, which may be configured for carrying out a DoS or a distributed DoS (DDoS) attack on the ACS may be prevented from doing so because they do not have access to the URI with the validation information. Connection requests from the attacker devices may therefore be refused by the DoS management interface, thus preventing a DoS or DDoS attack on the ACS.

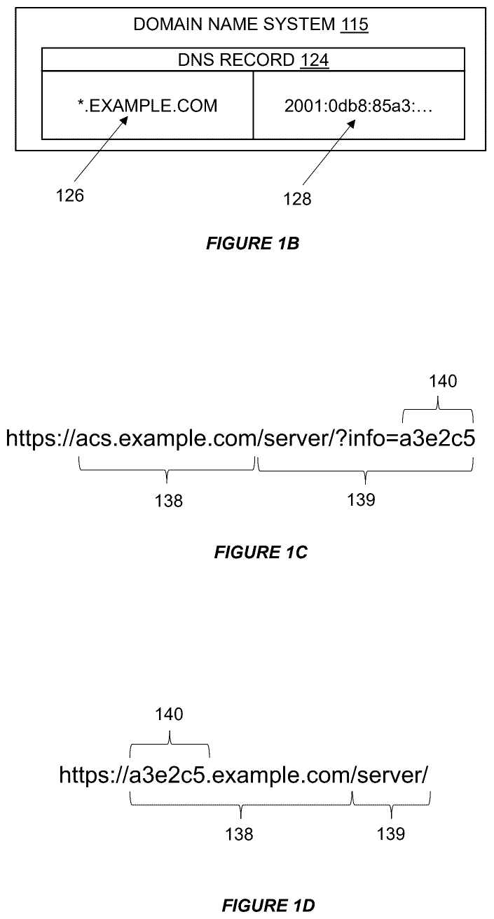

The system (100) described above may implement a method for DoS attack prevention in a security protocol. An exemplary method for DoS attack prevention in a security protocol is illustrated in the flow diagrams of FIGS. 2A and 2B.

The method may be preceded by configuration or steps which may for example include configuring a DNS to include a wildcard DNS record based on a first part of a domain name.

The method may commence with an end-user activity being initiated between an end-user device and a security protocol endpoint. Initiation of the activity may cause the security protocol endpoint and the end-user device to connect via a public network. The connection may be a secure connection.

The method may include receiving (202) a security protocol request message (such as an AReq message). The security protocol request message may be received from the security protocol endpoint (such as a 3DS server) via a private network. The security protocol request message may be received by a security protocol computing device (such as an ACS) via a private interface thereof.

The method may include obtaining (204) validation information usable in validating a connection request. The connection request for which the validation information is to be used may be a future, or to-be-initiated, or anticipated connection request. Obtaining the validation information may be in response to receiving the security protocol request message. The validation information may be obtained for use in compiling a URI. The URI may point to the security protocol computing device in a DNS associated with a public network. The URI may be usable by an end-user device in connecting to the security protocol computing device over the public network. The validation information may for example include or be in the form of a character string. In some examples, obtaining the validation information may include retrieving the validation information from a data store. In other examples, obtaining the validation information may include generating the validation information and optionally storing the validation information temporarily in a data store.

The method may include generating (208) a security protocol response message (such as an ARes message). Generating the security protocol response message may include inserting or including (210) the validation information in the security protocol response message. In some examples, the method includes or inserts, in the response message, the validation information and instructions for compiling the URI using the validation information. In such an example, generating the security protocol response message may include including a part or portion of the URI in the security protocol response message. In other examples, the method may include compiling the URI including the validation information and including the compiled URI in the security protocol response message. In other words, the security protocol response message may include either: the validation information; or, the URI including the validation information. Either way, the security protocol response message includes the URI.

Compiling the URI may include defining a fully qualified domain name (FQDN) using the validation information. The URI may for example include a domain name including a first part and a second part which contains the validation information. The second part of the URI may be a third or lower level domain field of the domain name. This may allow spurious requests submitted to the security protocol computing device via spurious URIs to be detected and rejected before a transport layer security (TLS) protocol handshake establishing a TLS session. The URI may be a uniform resource locator (URL).

The method may include transmitting (212) the security protocol response message to the security protocol endpoint (104) via the private network.

The security protocol endpoint may receive the security protocol response message including the validation information (or the compiled URI including the validation information) and may transmit the validation information (or the compiled URI including the validation information) to an end-user device for the end-user device to connect to the security protocol computing device via the public network. The end-user device may receive the validation information (or the compiled URI including the validation information). The end-user device may receive the validation information via a public network.

In examples where the end-user device receives the validation information (and not the compiled URI including the validation information), the end-user device may compile a URI using the validation information. This may include appending the validation information or a result generated based on the validation information to a part or portion of the URI at a predetermined location to output a compiled URI based on the validation information.

In some cases, this may require the end-user device generate a result based on the validation information. The result may be a proof-of-work result. For example, the end-user device may be required to determine a result in the form of a value which when hashed using the validation information generates an output which meets a predefined requirement (e.g., begins with a zero, or the like). In such an example, compiling the URI using the validation information includes compiling a URI using the result generated based on the validation information. In this way, a URI based on the validation information is compiled. In other cases, the end-user device compiles the URI by appending the validation information to a part of the URI at a predetermined location to output a compiled URI including the validation information.

The end-user device may then generate and transmit a connection request to the security protocol computing device using the URI. This may include transmitting the connection request using the URI including or based on the validation information.

Referring now to FIG. 2B, at some point, the method may include receiving (214) a request to connect to the security protocol computing device using the URI. The request may be received from the end-user device via the public network. The request may be received at a DoS management interface via the public network. In some examples, the URI includes a domain name including a first part and a second part which contains the validation information. In such examples, the request may be received via or using a DNS which is configured to include a wildcard DNS record based on the first part of the domain name.

The method may include, in response to receiving the request, validating (216) the request using the validation information.

In examples where the URI includes the validation information, validating the request may include extracting the validation information and using the extracted validation information to validate the request. In examples where the URI is based on the validation information, validating the request may include extracting, from the URI, a result generated using the validation information and validating the result using the validation information.

As mentioned, the validation information may include or be in the form of a character string, such as a token, nonce, identifier, or the like. Validating the request may include one or more of: checking a data store (107) for a copy of the character string; performing a cryptographic operation on the character string (e.g., decrypting the character string using an encryption key); parsing the character string to determine whether it meets expected requirements (e.g. as to content, length, sequence). In a proof-of-work example, validating the request using the validation information may include checking a result using the validation information (e.g., hashing the result using the validation information and comparing the output to a predefined requirement).

The method may include, when (218) the request is valid, permitting (220) the connection between the end-user device and the security protocol computing device. The method may include, when (222) the request is not valid, refusing (224) the connection between the end-user device and the security protocol computing device.

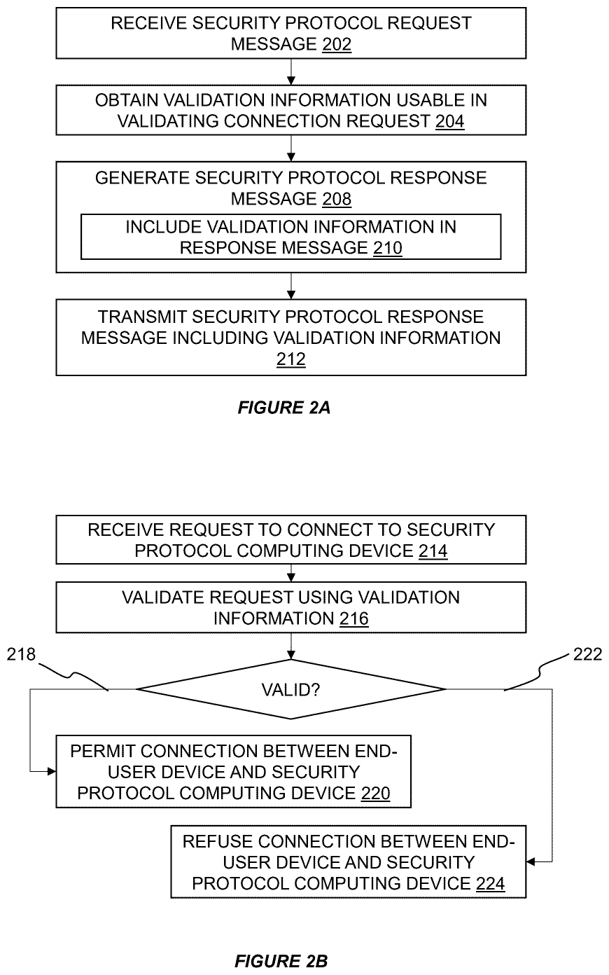

Another example method for DoS attack prevention in a security protocol is illustrated in the swim-lane flow diagram of FIG. 3, in which respective swim-lanes provide an example delineation of the different devices or interfaces at which or by which respective operations are performed. The method corresponds to the method described above with reference to FIGS. 2A and 2B and like reference numerals are used to indicate like operations. Generally, the operations described as being conducted by the security protocol computing device and the DoS management interface may be conducted by or on behalf of an entity. Some operations described as being conducted by the security protocol computing device (e.g., token generation and token storage) may be conducted by the DoS management infrastructure, and vice versa.

A security protocol computing device may receive (202) a security protocol request message associated with an end-user activity. The security protocol request message may be received from a security protocol endpoint via a private network. The security protocol request message may be received responsive to initiation of the end-user activity.

The security protocol computing device may obtain validation information usable in validating a connection request, including generating (250) a token or identifier which uniquely identifies the end-user activity. The security protocol computing device may store (252) the token or identifier in a data store. Storage may be temporary. For example, the token or identifier may be stored for as long as the end-user activity is pending or in-progress. The security protocol computing device may compile a URI using the validation information. This may include generating (254) a URI including the token or identifier.

Generating the URI may include generating a URI having a domain name which includes a first part and a second part which contains the validation information. The second part of the URI may for example be a third or lower level domain field of the domain name. Compiling the URI may therefore include defining a FQDN using the validation information. As will be explained, this may allow spurious requests submitted from attacker devices to the security protocol computing device via spurious URIs to be detected and rejected before a transport layer security (TLS) protocol handshake establishing a TLS session. In other words, the attack may be detected and prevented before initiating the computationally intensive TLS handshake.

The security protocol computing device may generate and transmit (256) a security protocol response message including the URI. The security protocol response message may be transmitted to the security protocol endpoint. The security protocol response message may be transmitted via the private network.

The security protocol endpoint may receive (258) the security protocol response message. The security protocol endpoint may transmit (260) the URI to an end-user device via a public network. Transmission may be via a secure connection over the public network.

The end-user device may receive (262) the URI from the security protocol endpoint. The end-user device may submit (264) a connection request using the URI. The connection request may be a request to connect to the security protocol computing device identified in the URI. The connection request may be transmitted via the public network. Submitting the connection request may include using a DNS to map the domain name included in the URI to an IP address of the security protocol computing device. As mentioned, the URI may include a first part and a second part. The DNS may include a wildcard DNS record which maps the first part of the domain name to a domain name and/or IP address of the security protocol computing device.

A DoS management interface may receive or intercept (266) the connection request. The DoS management interface may extract (268) validation information, in this example being the token or identifier, from the URI. The DoS management interface may validate (216) the connection request using the validation information. Validating the connection request may include checking (270) the data store for a copy of the token or identifier.

The DoS management interface may, in response to determining that the request is valid, permit (220) the connection between the end-user device and the security protocol computing device. Permitting the connection may for example be followed by the security protocol computing device establishing (272) a secure connection with the end-user device. This may for example include initiating a TLS handshake and establishing a TLS session. Once the secure connection has been established, the security protocol computing device and end-user device may exchange (274) further security protocol messages (such as CReq/CRes, or the like).

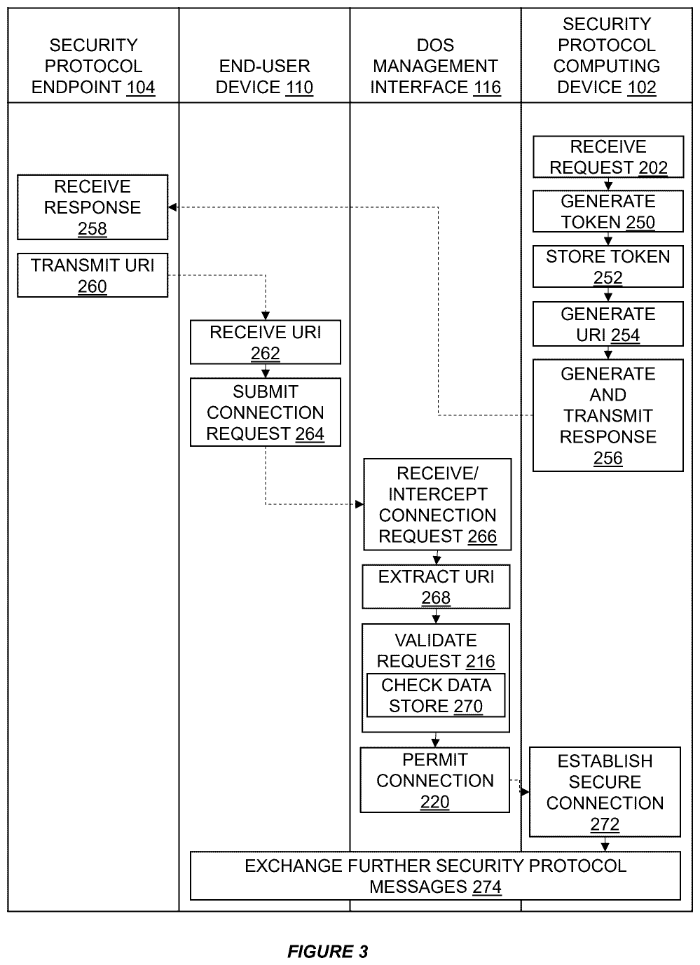

Various components may be provided for implementing the method described above with reference to FIGS. 2A to 3. FIG. 4 is a block diagram which illustrates exemplary components which may be provided by a system (100) for DoS attack prevention in a security protocol.

The system may include a processor (402) for executing the functions of components described below, which may be provided by hardware or by software units executing on the system. The software units may be stored in a memory component (404) and instructions may be provided to the processor (402) to carry out the functionality of the described components. In some cases, for example in a cloud computing implementation, software units arranged to manage and/or process data may be provided remotely.

The system may include an information obtaining component (406) arranged to obtain information (or validation information) usable in validating a connection request for use in compiling a uniform resource identifier (URI) usable by an end-user device in connecting to a security protocol computing device over a public network. The system may include a response message generating and transmitting component (408) arranged to include the validation information in a security protocol response message. The response message generating and transmitting component (408) may be arranged to transmit the security protocol response message to an endpoint via a private network. The system may include a connection control component (410) arranged, in response to receiving, via the public network, a request to connect to the security protocol computing device using the URI, to validate the request using the validation information and to permit connection to the security protocol computing device.

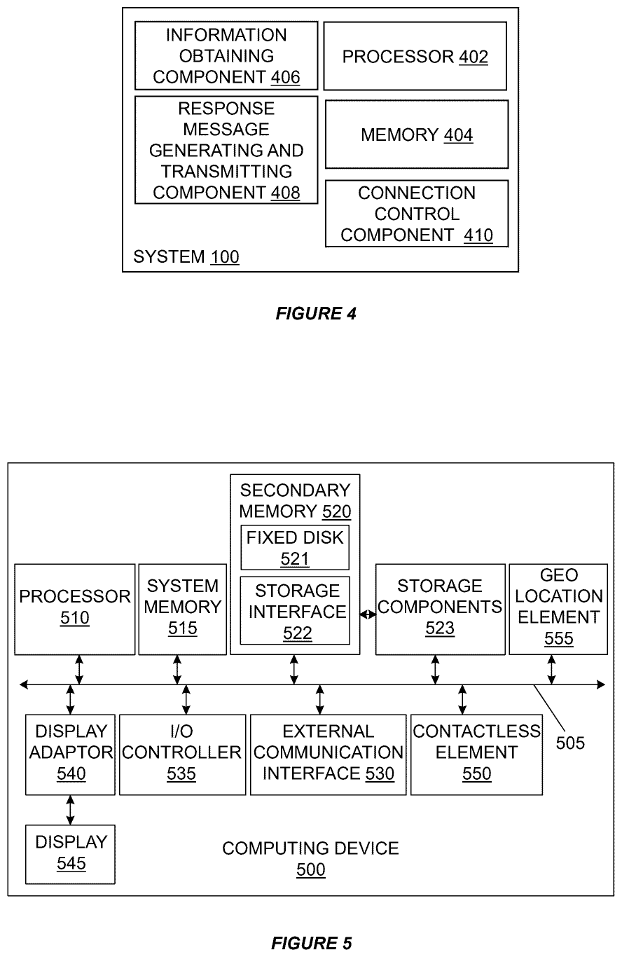

FIG. 5 illustrates an example of a computing device (500) in which various aspects of the disclosure may be implemented. The computing device (500) may be embodied as any form of data processing device including a personal computing device (e.g. laptop or desktop computer), a server computer (which may be self-contained, physically distributed over a number of locations), a client computer, or a communication device, such as a mobile phone (e.g. cellular telephone), satellite phone, tablet computer, personal digital assistant or the like. Different embodiments of the computing device may dictate the inclusion or exclusion of various components or subsystems described below.

The computing device (500) may be suitable for storing and executing computer program code. The various participants and elements in the previously described system diagrams may use any suitable number of subsystems or components of the computing device (500) to facilitate the functions described herein. The computing device (500) may include subsystems or components interconnected via a communication infrastructure (505) (for example, a communications bus, a network, etc.). The computing device (500) may include one or more processors (510) and at least one memory component in the form of computer-readable media. The one or more processors (510) may include one or more of: CPUs, graphical processing units (GPUs), microprocessors, field programmable gate arrays (FPGAs), application specific integrated circuits (ASICs) and the like. In some configurations, a number of processors may be provided and may be arranged to carry out calculations simultaneously. In some implementations various subsystems or components of the computing device (500) may be distributed over a number of physical locations (e.g. in a distributed, cluster or cloud-based computing configuration) and appropriate software units may be arranged to manage and/or process data on behalf of remote devices.

The memory components may include system memory (515), which may include read only memory (ROM) and random access memory (RAM). A basic input/output system (BIOS) may be stored in ROM. System software may be stored in the system memory (515) including operating system software. The memory components may also include secondary memory (520). The secondary memory (520) may include a fixed disk (521), such as a hard disk drive, and, optionally, one or more storage interfaces (522) for interfacing with storage components (523), such as removable storage components (e.g. magnetic tape, optical disk, flash memory drive, external hard drive, removable memory chip, etc.), network attached storage components (e.g. NAS drives), remote storage components (e.g. cloud-based storage) or the like.

The computing device (500) may include an external communications interface (530) for operation of the computing device (500) in a networked environment enabling transfer of data between multiple computing devices (500) and/or the Internet. Data transferred via the external communications interface (530) may be in the form of signals, which may be electronic, electromagnetic, optical, radio, or other types of signal. The external communications interface (530) may enable communication of data between the computing device (500) and other computing devices including servers and external storage facilities. Web services may be accessible by and/or from the computing device (500) via the communications interface (530).

The external communications interface (530) may be configured for connection to wireless communication channels (e.g., a cellular telephone network, wireless local area network (e.g. using Wi-Fi™), satellite-phone network, Satellite Internet Network, etc.) and may include an associated wireless transfer element, such as an antenna and associated circuitry.

The computer-readable media in the form of the various memory components may provide storage of computer-executable instructions, data structures, program modules, software units and other data. A computer program product may be provided by a computer-readable medium having stored computer-readable program code executable by the central processor (510). A computer program product may be provided by a non-transient or non-transitory computer-readable medium, or may be provided via a signal or other transient or transitory means via the communications interface (530).

Interconnection via the communication infrastructure (505) allows the one or more processors (510) to communicate with each subsystem or component and to control the execution of instructions from the memory components, as well as the exchange of information between subsystems or components. Peripherals (such as printers, scanners, cameras, or the like) and input/output (I/O) devices (such as a mouse, touchpad, keyboard, microphone, touch-sensitive display, input buttons, speakers and the like) may couple to or be integrally formed with the computing device (500) either directly or via an I/O controller (535). One or more displays (545) (which may be touch-sensitive displays) may be coupled to or integrally formed with the computing device (500) via a display or video adapter (540).

The foregoing description has been presented for the purpose of illustration; it is not intended to be exhaustive or to limit the technology to the precise forms disclosed. Persons skilled in the relevant art can appreciate that many modifications and variations are possible in light of the above disclosure.

Any of the steps, operations, components or processes described herein may be performed or implemented with one or more hardware or software units, alone or in combination with other devices. Components or devices configured or arranged to perform described functions or operations may be so arranged or configured through computer-implemented instructions which implement or carry out the described functions, algorithms, or methods. The computer-implemented instructions may be provided by hardware or software units. In one embodiment, a software unit is implemented with a computer program product comprising a non-transient or non-transitory computer-readable medium containing computer program code, which can be executed by a processor for performing any or all of the steps, operations, or processes described. Software units or functions described in this application may be implemented as computer program code using any suitable computer language such as, for example, Java™, C++, or Perl™ using, for example, conventional or object-oriented techniques. The computer program code may be stored as a series of instructions, or commands on a non-transitory computer-readable medium, such as a random access memory (RAM), a read-only memory (ROM), a magnetic medium such as a hard-drive, or an optical medium such as a CD-ROM. Any such computer-readable medium may also reside on or within a single computational apparatus, and may be present on or within different computational apparatuses within a system or network.

Flowchart illustrations and block diagrams of methods, systems, and computer program products according to embodiments are used herein. Each block of the flowchart illustrations and/or block diagrams, and combinations of blocks in the flowchart illustrations and/or block diagrams, may provide functions which may be implemented by computer readable program instructions. In some alternative implementations, the functions identified by the blocks may take place in a different order to that shown in the flowchart illustrations.

Some portions of this description describe the examples in terms of algorithms and symbolic representations of operations on information. These algorithmic descriptions and representations, such as accompanying flow diagrams, are commonly used by those skilled in the data processing arts to convey the substance of their work effectively to others skilled in the art. These operations, while described functionally, computationally, or logically, are understood to be implemented by computer programs or equivalent electrical circuits, microcode, or the like. The described operations may be embodied in software, firmware, hardware, or any combinations thereof.

The language used in the specification has been principally selected for readability and instructional purposes, and it may not have been selected to delineate or circumscribe the inventive subject matter. It is therefore intended that the scope of the present disclosure be limited not by this detailed description, but rather by any claims that issue on an application based hereon. Accordingly, the present disclosure is intended to be illustrative, but not limiting, of the scope of any accompanying claims.

Finally, throughout the specification and any accompanying claims, unless the context requires otherwise, the word ‘comprise’ or variations such as ‘comprises’ or ‘comprising’ will be understood to imply the inclusion of a stated integer or group of integers but not the exclusion of any other integer or group of integers.

1. A computer-implemented method for a denial-of-service attack prevention in a security protocol, the method comprising:
obtaining validation information usable in validating a connection request for use in compiling a uniform resource identifier (URI) usable by an end-user device in connecting to a security protocol computing device over a public network;
including the validation information in a security protocol response message and transmitting the security protocol response message to an endpoint via a private network; and,
in response to receiving, via the public network, a request to connect to the security protocol computing device using the URI, validating the request using the validation information and permitting connection to the security protocol computing device.

2. The method of claim 1, including compiling the URI, wherein the URI includes the validation information, and wherein the URI points to the security protocol computing device in a domain name system (DNS).

3. The method of claim 2, wherein including the validation information in the security protocol response message includes including the compiled URI including the validation information in the security protocol response message.

4. The method of claim 2, wherein the URI includes a domain name including a first part and a second part which contains the validation information, and wherein the second part of the URI is a third or lower level domain field of the domain name.

5. The method of claim 4, including configuring the DNS to include a wildcard DNS record based on the first part of the domain name.

6. The method of claim 2, wherein compiling the URI includes defining a fully qualified domain name (FQDN) using the validation information.

7. The method of claim 1, wherein the method allows spurious requests submitted to the security protocol computing device via spurious URIs to be detected and rejected before a transport layer security (TLS) protocol handshake establishing a TLS session.

8. The method of claim 1, wherein the URI is a uniform resource locator (URL).

9. The method of claim 1, wherein the validation information is any one of: limited-use information; valid for a limited period of time; activity- or session-specific; and, is in the form of a token uniquely generated for an end-user activity.

10. The method of claim 1, including periodically repeating to obtain new validation information.

11. The method of claim 1, wherein obtaining the validation information is in response to a security protocol authentication request for a transaction, and wherein the method repeats for each transaction.

12. The method of claim 1, wherein obtaining the validation information includes obtaining the validation information from a data store, and wherein the data store is a key-value store.

13. The method of claim 12, wherein the data store forms part of a security protocol infrastructure and is configured to store transaction tokens temporarily for in-progress transactions.

14. The method of claim 12, wherein using the validation information to validate the request includes validating the validation information, and wherein validating the validation information includes searching the data store for the validation information.

15. The method of claim 1, including, in response to receiving a request to connect to the security protocol computing device via another URI which does not include the validation information, failing to validate the request and declining to permit the connection.

16. The method of claim 1, wherein the security protocol response message is a security protocol authentication response sent via a security protocol directory server.

17. The method of claim 1, wherein the security protocol is a three-domain secure (“3DS”) security protocol and the security protocol computing device is an access control server (ACS).

18. A system for a denial-of-service attack prevention in a security protocol, the system comprising: a non-transitory computer-readable storage medium; and one or more processors coupled to the non-transitory computer-readable storage medium, wherein the non-transitory computer-readable storage medium comprises program instructions that, when executed on the one or more processors, cause the system to perform operations comprising:
obtaining validation information usable in validating a connection request for use in compiling a uniform resource identifier (URI) usable by an end-user device in connecting to a security protocol computing device over a public network;
including the validation information in a security protocol response message and transmitting the security protocol response message to an endpoint via a private network; and,
in response to receiving, via the public network, a request to connect to the security protocol computing device using the URI, validating the request using the validation information and permitting connection to the security protocol computing device.

19. A computer program product for a denial-of-service attack prevention in a security protocol, the computer program product comprising a computer-readable medium having stored computer-readable program code for performing the steps of:
obtaining validation information usable in validating a connection request for use in compiling a uniform resource identifier (URI) usable by an end-user device in connecting to a security protocol computing device over a public network;
including the validation information in a security protocol response message and transmitting the security protocol response message to an endpoint via a private network; and,
in response to receiving, via the public network, a request to connect to the security protocol computing device using the URI, validating the request using the validation information and permitting connection to the security protocol computing device.
